(19) United States
(12) Patent Application Publication
(10) Pub. No.: US 2026/0028182 A1
(43) Pub. Date: Jan. 29, 2026

(54) RESERVOIR AND METHOD FOR OPERATING THE RESERVOIR

(71) Applicant: G.D S.P.A., Bologna (BO) (IT)

(72) Inventors: Valerio AMORATI, Bologna (BO) (IT); Manuele CUCCHI, Bologna (BO) (IT); Giampaolo GIANESE, Bologna (BO) (IT); Mirco LEGNANI, Bologna (BO) (IT); Luca TESTONI, Bologna (BO) (IT)

(21) Appl. No.: 18/997,662

(22) PCT Filed: Jul. 18, 2023
(86) PCT No.: PCT/IB2023/057300

§ 371 Date: Jan. 22, 2025

(30) Foreign Application Priority Data
Jul. 25, 2022 (IT) 102022000015564

(51) Int. Cl. B65G 1/04; B65G 47/90

(52) U.S. Cl. CPC B65G 1/0485; B65G 1/045; B65G 47/90; B65G 2203/0266

(57) ABSTRACT

Described is a reservoir including a feed station equipped with a feed transfer device and associated or associable with a respective feed line, a pickup station equipped with a pickup transfer device and associated or associable with at least one respective removal line, a movable support provided with receiving seats which move along a closed path passing through the feed station and the pickup station, detecting means for detecting a filled condition of at least some of the receiving seats, and a control unit configured to drive the transfer devices as a function of current capacity values of the feed line and of the removal line, wherein the control unit is connected to the detecting means and is configured to move the transfer devices as a function of the filled conditions received from the detecting means, so as to place the articles in receiving seats detected as being currently available and/or to pick up articles from receiving seats detected as currently containing an article.

### TECHNICAL FIELD

This invention relates to a reservoir and to a method for operating the reservoir.

The invention addresses the sector of industrial processes for the production, processing and packaging of articles in general. The type of articles, therefore, is not a limiting factor in the context of this invention. Whatever the case, by “article” is meant, preferably, a single object which can be gripped, transported and released individually. By way of a non-exhaustive example, the following may be considered articles according to this invention: food or confectionery products; components or sub-units of electronic cigarettes; electronic components; small mechanical parts.

### BACKGROUND ART

Known in the prior art are product reservoirs, multi-level in some cases, provided with input and output transfer devices. These, however, have complex structures which require stringent FIFO (first in first out) or LIFO (last in first out) programs.

In particular, tower solutions are known, where the products are stored on different levels and taken in or out by suitable transfer devices which must constantly move in three dimensions, vertically to reach the necessary level and horizontally in a plane at the level reached.

Also known are moving belt reservoirs, for example, in the cigarette sector, for temporarily storing a mass of cigarettes of variable volume along a helical path. This solution, which may involve both LIFO and FIFO systems, requires large, complex structures and, potentially, even long-term product storage and the impossibility of selecting specific quantities of the product to be withdrawn.

### DISCLOSURE OF THE INVENTION

The Applicant has noticed that these solutions can be improved in terms of accessibility, that is to say, versatility in the product input and output procedures.

In this context, the basic technical purpose of this invention is to provide a reservoir and a method for operating the reservoir to overcome the above mentioned disadvantages of the prior art.

In particular, the aim of this invention is to provide a reservoir and a method for operating the reservoir which achieve improved accessibility compared to the prior art.

The technical purpose indicated and the aim specified are substantially achieved by a reservoir and a method for operating the reservoir comprising the technical features set out in claims 1 and 11 and/or in one or more of the claims dependent thereon.

### BRIEF DESCRIPTION OF THE DRAWINGS

Further features and advantages of the invention are more apparent in the non-limiting description which follows of a preferred but non-exclusive embodiment of a reservoir and a method for operating the reservoir, as illustrated in the accompanying drawings, in which:

FIG. 1 is a simplified perspective view of a reservoir according to this invention;

FIG. 2 shows a schematic plan view of the reservoir of FIG. 1;

FIG. 3 shows an enlarged view of a portion of the reservoir of FIG. 1.

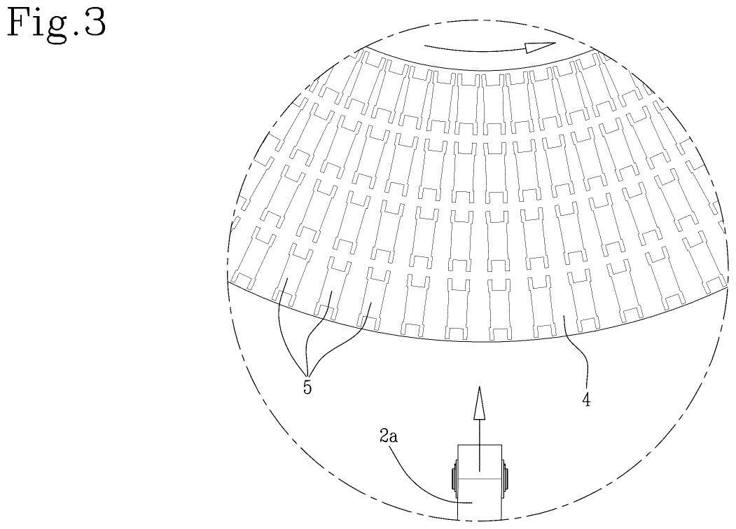

### DETAILED DESCRIPTION OF PREFERRED EMBODIMENTS OF THE INVENTION

The numeral 1 in the accompanying drawings denotes in its entirety a reservoir according to this invention, suitable for the temporary storage of articles.

In the context of this invention, the term “articles” is used to denote products of diverse kinds such as, by way of non-limiting example: food or confectionery products; components or sub-units of electronic cigarettes; electronic components; small mechanical parts.

Regardless of the type of product, the reservoir 1 is suitable for working between a production line upstream and a processing or packaging line downstream, to hold or deliver articles when the capacities of the lines upstream and downstream are imbalanced.

The reservoir 1 is, in particular, a “dynamic” reservoir, that is to say, suitable for the temporary storage of articles based on one or more criteria which take into account how full it is at any time, hence not necessarily linked to a sequential order of filling.

Moreover, the reservoir 1 is of a mobile type, that is to say, normally mobile in such a way as to move the articles and the respective housings cyclically, in particular with continuous and/or uniform motion.

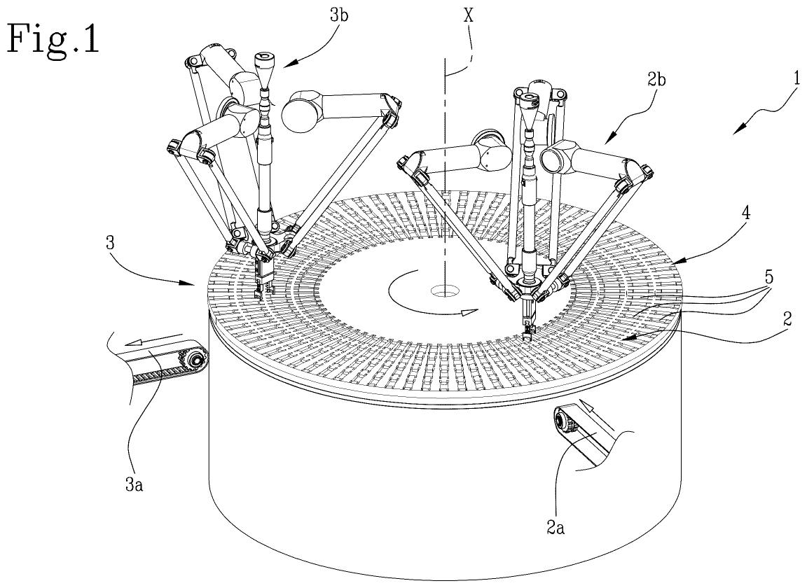

Looking in more detail, as shown in FIG. 1, the reservoir 1 comprises one or more feed stations 2, each associated or associable with at least one respective feed line 2a for feeding articles and equipped with a respective feed transfer device 2b, and one or more pickup stations 3, each associated or associable with at least one respective removal line 3 for removing articles and equipped with a respective pickup transfer device 3b.

The reservoir 1 also comprises a movable support 4 provided with a plurality of receiving seats 5 for receiving single articles (not illustrated) and configured to move the receiving seats 5 along a closed path passing through the feed station 2 and the pickup station 3 so that the articles are fed to the movable support 4 by the feed transfer device (or devices) 2b and the articles are removed from the movable support 4 by the pickup transfer device (or devices) 3b.

The reservoir 1 is configured to move individual articles towards and away from the movable support 4; in other words, the transfer devices 2b, 3b are configured to pick up, transfer and release one single article at a time (according to the embodiment illustrated). Alternatively, the transfer devices 2b, 3b may be configured to pick up, transfer and release a group of articles at a time.

The transfer devices 2b, 3b illustrated are in the form of articulated arms; they may, however, be embodied in any form, for example, Cartesian actuators, anthropomorphic robots and so on.

Preferably, the receiving seats 5 are distributed on the movable support 4 according to a two-dimensional distribution, in particular, in a plurality of longitudinal rows (circles) running alongside each other.

The movable support 4 is made preferably in the form of a carousel or rotary disc, in particular, rotating about a vertical axis X. The carousel or rotary disc has an integral structure, that is to say, all the receiving seats 5 are movable along the closed path simultaneously.

Preferably, the movable support 4 moves with continuous motion, in particular at a constant speed, along the closed path.

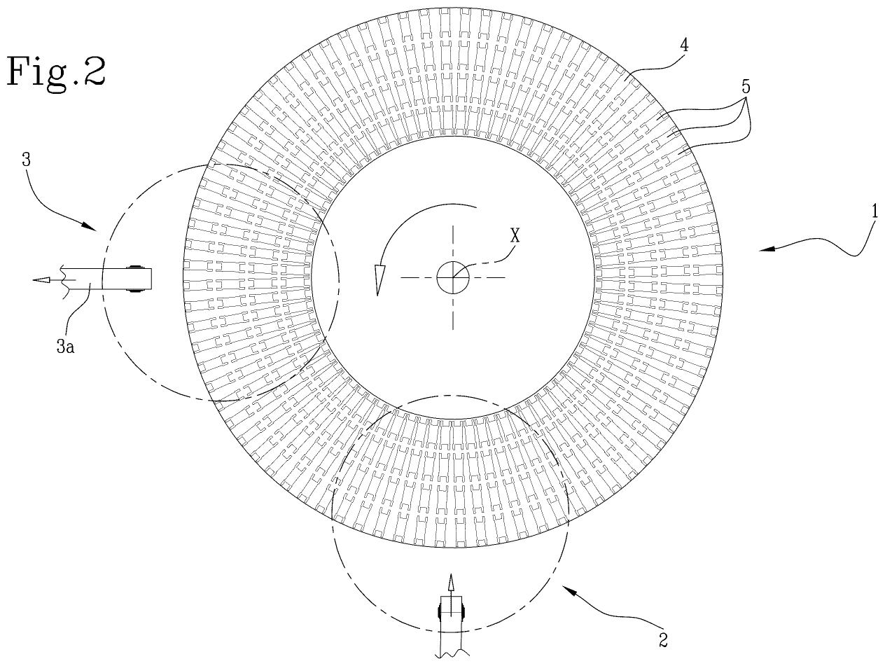

FIG. 2 shows a plan view of the reservoir 1, where the operating range of each of the two transfer devices 2b, 3b is drawn with a dashed line. Preferably, the operating range is substantially circular, although other shapes are imaginable (for example, rectangular or square in the case of Cartesian actuators).

According to the invention, the reservoir 1 also comprises detecting means (not illustrated) for detecting a filled condition of at least some of the receiving seats. In particular, the detecting means can detect a filled condition only of the receiving seats 5 that are currently within the operating ranges of the transfer devices 2b, 3b, or a filled condition of the receiving seats 5 located in portions of the movable support 4 outside the operating ranges of the transfer devices 2b, 3b, or a filled condition of all the receiving seats 5 on the movable support 4.

Preferably, the detecting means are configured to detect the filled condition at predetermined time intervals, in particular, at time intervals preferably shorter than the time that elapses between the passage of one receiving seat 5 and the next receiving seat 5. More preferably, detection occurs at a frequency greater than or equal to 5 Hz, which, in the context of this use, corresponds to continuous or “quasi-continuous” detection.

In a preferred embodiment, the detecting means comprise one or more cameras, for example, located above the movable support 4.

In an alternative solution, the detecting means are presence sensors inside each receiving seat 5 and configured to generate an article present and/or absent signal at the aforesaid predetermined frequency or to detect an absent/present variation condition and vice versa.

The detecting means thus generate respective (optical and/or electrical) signals identifying the filled condition of at least some of the receiving seats 5 of the movable support 4.

The reservoir 1 also comprises a control unit (not illustrated) connected to the transfer devices 2b, 3b and configured to drive the transfer device 2b, 3b as a function of the current capacity values of the feed and removal lines 2a, 3a. In particular, the control unit is configured to drive each transfer device 2b, 3b independently and at a variable transfer frequency or speed, for example, greater if the respective feed/removal line 2a, 3a is fully operational, and smaller if the respective feed/removal line 2a, 3a is operating at a reduced capacity (for example, on account of slowdowns in production or processing units upstream), and even to stop the transfer device 2b, 3b completely if the respective feed/removal line 2a, 3a is down.

In the context of this disclosure, the expression “current capacity” means the quantity (or flow) of articles per unit time at a given instant (measured, for example, in articles/second or articles/minute).

Furthermore, according to the invention, the control unit is connected to the detecting means and configured to operate according to a programmed logic of driving the transfer devices 2b, 3b as a function of the filled conditions received from the detecting means, so as to place the articles in receiving seats 5 detected as being currently available and/or to pick up articles from receiving seats 5 detected as currently containing an article.

In particular, therefore, the control unit contains one or more drive logics used to determine the sequence of releasing the articles into the receiving seats 5 or picking up the articles from the receiving seats 5, taking into account not only the current capacity conditions of the feed and removal lines 2a, 3a but also the current distribution of the articles (full/empty seats 5) on the movable support 4.

Preferably, the control unit is configured to make the articles distributed on the movable support 4 more closely packed or thinned out, in particular progressively and evenly over the whole surface of the movable support 4, so as to prevent individual sub-areas of the movable support 4 from being filled completely (or emptied completely), while other sub-areas are, at the same time, only partially filled). This has the effect of optimizing the distribution of the articles in that, mainly in the case of continuous advancing motion of the receiving seats 5 along the closed path, each feed station 2 would always have empty receiving seats 5 available to it, and each removal station 3 would always have available it full receiving seats 5 from which articles can be picked up. If this were not the case, hence in the case of areas (or “islands”) that are all full or all empty, the corresponding feed or removal station 2, 3 would have to stop and wait for the next instant, thereby going “out of step” or creating delays which, in some operating conditions, might not be able to be compensated.

The effect of packing more closely or of thinning out must be understood as “distributed” over the entire surface of the movable support 4 and not only locally in specific areas thereof.

In other words, therefore, the control unit contains one or more drive logics, such as to:
drive the feed transfer devices 2b in such a way as to gradually make the articles more closely packed on the movable support 4 gradually by not filling some areas completely, excepting the completely full condition that would take place in the last cycle (rotation) of the movable support 4; and/or
drive the removal transfer devices 3b in such a way as to gradually thin out the articles on the movable support 4 gradually by not emptying some areas completely, excepting the completely empty condition that would take place in the last cycle (rotation) of the movable support 4.

In an example embodiment, a control logic might be that of releasing the articles onto the movable support 4 in order to fill it in “checkerboard” or similar fashion, to create a predetermined number of alternate empty and full receiving seats 5, and similarly, to pick up the articles from the movable support 4 so that the articles remaining are also arranged in “checkerboard” fashion.

Preferably, closely packing/thinning out is also obtained by releasing/removing the articles onto/from the movable support 4 at a speed (frequency) different from, in particular lower than, the transit frequency of the receiving seats 5. For example, if 40 receiving seats transit a given section of the movable support 4 in an interval of 5 seconds, the transfer devices 2b (and, similarly, the removal transfer devices 3b) are able to exchange a smaller number of article, for example 20 (hence, their maximum releasing frequency is lower than the transit frequency of the articles). This maximizes the assortment of receiving seats 5 at work (that is, full/empty) available to the removal/feed stations 2, 3 while the transfer devices 2b, 3b continue to work at speeds suitable for performing article transfers according to the programmed logic of the control unit.

Preferably, the transfer devices 2b, 3b are operated at a constant transfer speed and stopped when there are no available receiving seats 5. In an alternative solution, the transfer devices 2b, 3b are operated at a transfer speed greater than or equal to a maximum speed, as a function of transfer requirements, and stopped when there are no available receiving seats 5.

According to a further aspect of the invention, and according to an embodiment not illustrated, there are two or more feed stations and/or two or more pickup stations. In this case, the control unit is configured to monitor a current capacity value of each of the feed and pickup lines, to determine the total current feed capacity and the total current pickup capacity and to determine a current imbalance defined by the difference between these total capacities. If the difference between the total capacities is greater than a preset threshold, the control unit is configured to activate a different number of feed and/or pickup stations to at least partly compensate for the imbalance.

This activation function given to the control unit has the purpose of optimizing the operating efficiency of the reservoir since excessive imbalance between input and output would cause the reservoir 1 to be quickly filled up or emptied completely, thereby losing its buffer storage function.

The invention achieves the preset aim, overcoming the disadvantages of the prior art.

Indeed, the reservoir is configured to fill/empty the receiving seats in a gradual and distributed manner so that there are receiving seats available to receive or deliver articles at all times, thus optimizing the accessibility of the reservoir to the transfer devices. This has the effect of maximizing the operating efficiency of the reservoir by enabling it to receive and deliver products at all times, between the extreme cases where it is completely empty or completely full.

1. A reservoir, comprising:
at least one feed station equipped with a feed transfer device and associated or associable with at least one respective feed line for feeding articles;
at least one pickup station equipped with a pickup transfer device and associated or associable with at least one respective removal line for removing articles;
a movable support provided with a plurality of receiving seats for receiving single articles and configured to move the receiving seats along a closed path passing through the feed station and the pickup station so that the articles are fed to the movable support by the feed transfer device and the articles are removed from the movable support by the pickup transfer device;
detecting means for detecting a filled condition of at least some of the receiving seats;
a control unit connected to the transfer devices and configured to drive the transfer devices as a function of current capacity values of the feed line and of the removal line,
wherein the control unit is also connected to the detecting means and configured to operate according to a logic of driving the transfer devices as a function of the filled conditions received from the detecting means, so as to place the articles in receiving seats detected as being currently available and/or to pick up articles from receiving seats detected as currently containing an article.

2. The reservoir according to claim 1, wherein the control unit is configured to make the articles distributed on the movable support more closely packed or thinned out, in particular progressively and evenly over the whole surface of the movable support, so as to prevent individual sub-areas of the movable support from being filled completely or emptied completely, respectively.

3. The reservoir according to claim 1, wherein the detecting means are configured for detecting, in particular continuously, a filled condition of portions of the movable support that are disposed at the feed station and pickup station, these portions of the movable support being defined by the operating range of the respective transfer devices.

4. The reservoir according to claim 1, wherein the detecting means are configured for detecting, in particular continuously, a filled condition of all the receiving seats portions of the movable support.

5. The reservoir according to claim 1, wherein the receiving seats are distributed on the movable support according to a two-dimensional distribution, in particular, in a plurality of longitudinal rows running alongside each other.

6. The reservoir according to claim 1, wherein the movable support is made in the form of a carousel or rotary disc, in particular, rotating about a vertical axis.

7. The reservoir according to claim 1, wherein all the receiving seats are movable along the closed path simultaneously.

8. The reservoir according to claim 1, wherein the movable support moves along the closed path continuously, preferably at a constant speed.

9. The reservoir according to claim 1, wherein the feed transfer device and/or the pickup transfer device are configured for individually transferring single articles and are preferably embodied in the form of motor-driven or robotized arms.

10. The reservoir according to claim 1, comprising two or more feed stations and/or two or more pickup stations, wherein the control unit is configured to monitor a current capacity value of each of the feed lines and pickup lines, to determine the total current feed capacity and the total current pickup capacity and to determine a current imbalance defined by the difference between these total capacities; the control unit being also configured to enable a different number of feed stations and/or pickup stations to at least partly compensate for the imbalance when the difference between the total capacities is greater than a predetermined threshold.

11. A method for operating a reservoir, in particular, a reservoir according to claim 1, wherein the reservoir comprises at least one feed station associated with at least one respective feed line for feeding articles and equipped with a feed transfer device, at least one pickup station associated with at least one respective removal line for removing articles and equipped with a pickup transfer device, and a movable support provided with a plurality of receiving seats for receiving single articles, the method comprising the following steps:
moving the movable support in such a way as to move the receiving seats along a closed path passing through the feed station and the pickup station so that the articles are fed to the movable support by the feed transfer device and the articles are removed from the movable support by the pickup transfer device;
detecting a filled condition of at least some of the receiving seats;
operating according to a logic of driving the transfer devices as a function of current capacity values of the feed line and of the removal line, wherein the logic of driving the transfer devices is also implemented as a function of the receiving seats filled conditions, so as to place the articles in receiving seats detected as being currently available and/or to pick up articles from receiving seats detected as currently containing an article.

12. The method according to claim 11, wherein the transfer devices are driven in such a way as to make the articles distributed on the movable support more closely packed or thinned out, in particular progressively and evenly over the whole surface of the movable support, so as to prevent individual sub-areas of the movable support from being filled completely or emptied completely, respectively.

13. The method according to claim 12, wherein the step of detecting a filled condition of at least some of the receiving seats is carried out by detecting, in particular continuously, a filled condition at least of portions of the movable support that are disposed at the feed station and pickup station, these portions being defined by the operating range of the respective transfer devices.

14. The method according to claim 12, wherein the reservoir comprises two or more feed stations and/or two or more pickup stations, further comprising the following steps:
monitoring a current capacity value of each of the feed lines and pickup lines associated with the stations, thereby determining a total current feed capacity and a total current pickup capacity;
determining a current imbalance defined by the difference between the total capacities;
enabling a different number of feed stations and/or pickup stations to at least partly compensate for the imbalance when the difference between the total capacities is greater than a predetermined threshold.
